(19) United States
(12) Patent Application Publication
(10) Pub. No.: US 2004/0177381 A1
(43) Pub. Date: Sep. 9, 2004

(54) Home network system which supports legacy digital set top box devices

(75) Inventors: Avi Kliger, Givatayim (IL); Yossi Erlich, Hod Hasharon (IL); Avi Shabtay, Herzlia (IL); Nachum Avishay, Rehovot (IL)

Correspondence Address: TESTA, HURWITZ & THIBEAULT, LLP, HIGH STREET TOWER, 125 HIGH STREET, BOSTON, MA, 02110, US

(73) Assignee: Tiaris, Inc., Herzelia (IL)

(21) Appl. No.: 10/654,191

(22) Filed: Sep. 3, 2003

Related U.S. Application Data
(60) Provisional application No. 60/408,307, filed on Sep. 5, 2002.

(51) Int. Cl. H04N 7/173; H04N 7/16

(52) U.S. Cl. 725/131; 725/139; 725/105

(57) ABSTRACT

A home content distribution solution that provides distribution capabilities between a Home Media Server (HMS) and remote units, such as a thin Client stand-alone box or an existing legacy digital set-top box (STB). The invention permits combined video and data home networking while leveraging the numbers of already deployed digital set-top boxes. Embodiments of the system and methods are employed to distribute content to a set-top box connected to a home distribution network, which preferably includes a home media server connected to the home distribution network; a reflector, and; an entry point device having entry terminal for connection to an external cable network, a first output terminal for connection to the home distribution network and a second output terminal for connection to the reflector. Content is typically obtained from both the home media server and the cable network and distributed over the home distribution network. The content obtained from both the home media server and the cable network is displayable by an analog television connected to the set-top box.

### RELATED APPLICATIONS

This application claims the benefit of and priority to the co-pending U.S. Provisional Application, Serial No. 60/408,307, filed Sep. 5, 2002, entitled “Combination of a Home Network Unit and a Support for Legacy Digital STB Devices” the entire contents of which are incorporated herein by reference.

This application further claims the benefit of and priority to the co-pending U.S. Non-Provisional application Ser. No. 10/234,358 filed Sep. 4, 2002 entitled “Home Network System and Method,” which claims the benefit of and priority to U.S. Non-provisional application Ser. No. 09/943,424 filed Aug. 30, 2001, which claims the benefit of the filing date of co-pending U.S. Provisional Application, Serial No. 60/229,263, filed Aug. 30, 2000, entitled “Home Network Method And Apparatus,” Provisional Application, Serial No. 60/230,110, filed Sep. 5, 2000, entitled “Home Network Method And Apparatus,” Provisional Application, Serial No. 60/275,060, filed Mar. 12, 2001, Provisional Application, Serial No. 60/291,130, filed May 15, 2001, and Provisional Application, Serial No. 60/297,304, filed Jun. 11, 2001, the entirety of which provisional and non-provisional applications are incorporated by reference herein.

### FIELD OF THE INVENTION

The invention relates generally to a home network content distribution system and more specifically to a home network content distribution system that provides content to legacy digital set-top boxes.

### BACKGROUND OF THE INVENTION

As the demand for the ability to distribute media content from a home media server into various rooms of the home increases, those who make the hardware for such content distribution are faced with the following reality. First, there is a significant home distribution network infrastructure, in the form of coaxial cables, already in place in a large number of residences. Second a large number of residences already possess a digital set-top box to which is connected an analog television.

Hardware manufacturers have developed thin-client hardware that is placed into each room to which home media server content is to be distributed. This hardware converts the signals from the home media server into signals understandable by television receivers. Such thin-client hardware communicates with the home media server by way of the existing home distribution network coaxial wire infrastructure. Although such thin client hardware does provide a means of distributing content to each room with thin-client hardware using one portion of the installed base (i.e. the coaxial wires), such a system generally does not provide any mechanism to permit existing or legacy digital set-top boxes to receive such content from the home media server without this thin client hardware.

The present invention addresses the need for allowing legacy set-top boxes to receive and play home media server content without requiring additional thin-client hardware and while permitting standard cable television signals to enter and be distributed by the home distribution network.

### SUMMARY OF THE INVENTION

The present invention relates to a home content distribution solution that provides distribution capabilities between a Home Media Server (HMS) and remote units, such as a thin Client stand-alone box or an existing legacy digital set-top box (STB). The invention permits combined video and data home networking while leveraging the numbers of already deployed digital set-top boxes. Only in circumstances in which there are no legacy digital set top boxes are installed are new thin client boxes required.

In one embodiment a system for distributing content to a set-top box connected to a home distribution network includes a home media server connected to the home distribution network; a reflector, and; an entry point device having entry terminal for connection to an external cable network, a first output terminal for connection to the home distribution network and a second output terminal for connection to the reflector. In this embodiment the content is obtained from both the home media server and the cable network and distributed over the home distribution network. The content obtained from both the home media server and the cable network is displayable by an analog television connected to the set-top box.

In another embodiment, the home media server communicates commands with the set-top box over the home distribution network using a command channel. In yet another embodiment, the command channel uses the reverse data band.

In still another embodiment, the content from the home media server is carried over the home distribution network within a first predetermined frequency band; the content from said cable network is carried over the home distribution network within a second predetermined frequency band; and the home media server is controlled by a home media server control signal from said set-top box, that is carried over said home distribution network within a third predetermined frequency band.

In another embodiment, the entry point device includes a low pass filter connected to the entry terminal and a directional coupler connected between the low pass filter and the first and second output terminals. In one embodiment the reflector is an active reflector. The reflector includes a reflector input terminal, a reflector diplexer, a reflector RF section and a SAW filter. The reflector diplexer has a first diplexer output and a first diplexer input and a second diplexer input connected to the reflector input terminal. The reflector RF section has a first RF input connected to said first diplexer output, a second RF input, a first RF output connected to said first diplexer input, and a second RF output. The SAW filter has a SAW input connected to said second RF section output and a SAW output connected to said second RF section input. In this embodiment the active reflector receives signals in a first band and reflects them in a second band having a lower frequency than said first band.

In still yet another embodiment, the home media server includes an HMS diplexer, an HMS RF section and an HMS signal processor. The HMS diplexer has a first HMS diplexer input, a first HMS diplexer output and a second HMS diplexer input connected to the home media server input. The HMS RF section has a first HMS RF section input connected to the HMS diplexer output, two second HMS RF section inputs, a first HMS RF section output connected to the HMS diplexer input, and a second HMS RF section output. The HMS signal processor has a first HMS signal processor input connected to the second HMS RF section output. The HMS signal processor also has two HMS signal processor outputs, one of each is connected to a respective one of the two second HMS RF section inputs.

The invention also relates to a method for distributing content from an external cable network and a home media server to a set-top box connected to a home distribution network. The method includes the steps of passing content carried by a first predetermined frequency band from the cable network to the set-top box over the home distribution network; passing control signals carried by a second predetermined frequency band from the set-top box to the home media server over the distribution network; and passing content carried by a third predetermined frequency band from the home media server to the set-top box over the home distribution network.

### DESCRIPTION OF THE DRAWINGS

The aspects of the invention presented above and many of the accompanying advantages of the present invention will become better understood by referring to the included drawings, which show a system according to the preferred embodiment of the invention and in which:

FIG. 1 depicts a schematic representation of typical prior art home distribution system in which two analog televisions are directly connected to a cable network system and two analog televisions are connected to the cable network system through digital set-top box.

FIG. 2 depicts a schematic representation of a home media server directly connected to an entry point device to the cable network system as known in the prior art.

FIG. 3 depicts a block diagram of one embodiment of the present invention.

FIG. 4 depicts a more detailed schematic drawing of the embodiment shown in FIG. 3, illustrating a home media server, a passive entry point device and a reflector, each connected to home distribution network.

### DESCRIPTION OF THE PREFERRED EMBODIMENTS

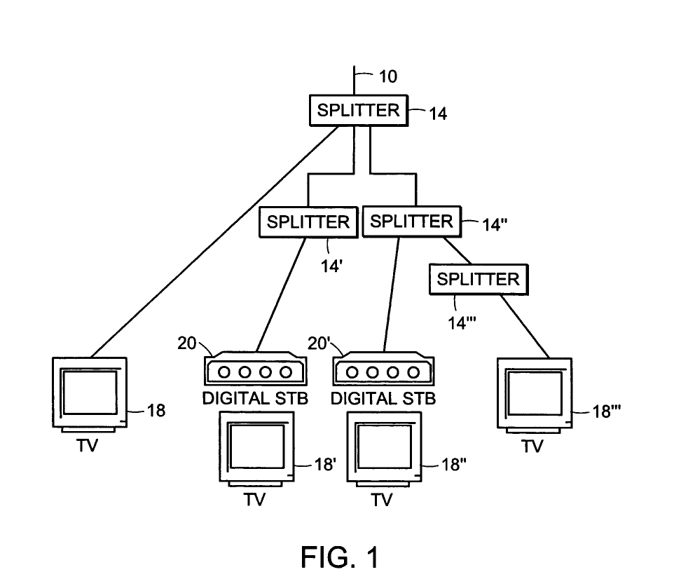

Referring to FIG. 1, a typical home distribution network known to the prior art includes an entry point 10 which provides input from an external cable network. The signals from the entry point 10 are distributed by way of a plurality of splitters 14, 14′, 14″, 14′″ (generally 14) over coaxial cables to a plurality of televisions 18, 18′, 18″, 18′″ (generally 18) either through a direct connection (18, 18′″) or through a digital set-top box 20, 20′ (generally 20).

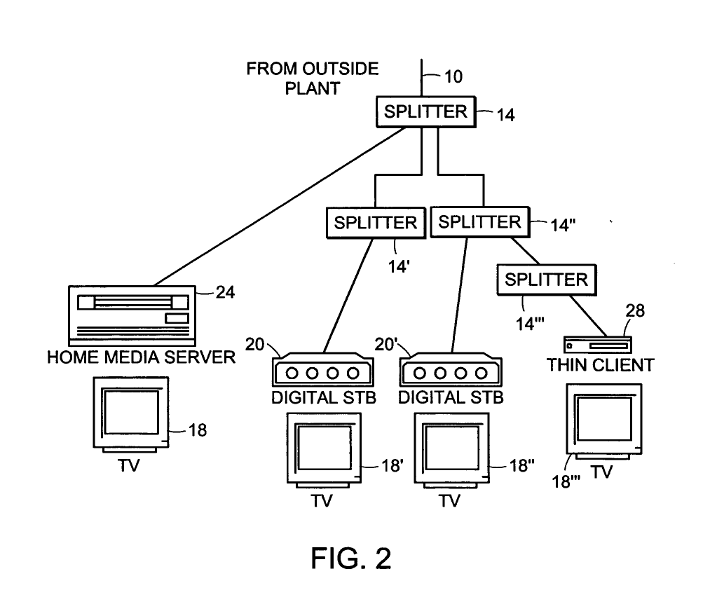

When a home media server 24 is included in the network (FIG. 2) it can be directly connected to the first splitter 14 and, optionally, can communicate with a thin-client 28 through the home distribution network. For this arrangement to function properly, the home media server 24 has to be placed in a room which has a direct coaxial connection to the first splitter 14. If the home media server 24 is connected to the home distribution network at a splitter which is not located at the entry point 10 (such as 14′″), the home distribution network can cause problems that legacy digital set-top boxes are not designed to support. For example, such an arrangement can lead to the production of multipath effects. Further, if a set-top box and the home media server are connected to the same splitter and the splitter isolation is not sufficient, the signal transmitted from the home media server can interfere with the digital set-top box signal.

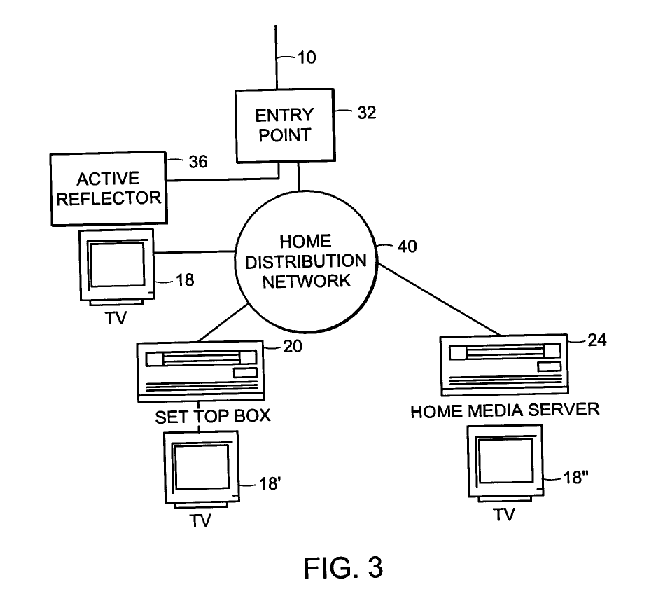

In brief overview, an embodiment of a new system which avoids these problems is shown in FIG. 3. In this embodiment, a connection to the external cable network 10 is made through an entry point device 32 which splits the cable network signal. Part of the signal is sent to an active reflector 36, which is connected directly to the entry point device 32. The remaining signal is sent to the home distribution network 40. Digital set-top boxes 20, analog televisions 18 and the home media server 24 can reside anywhere in the house, and can be moved to other coaxial cable outlets as desired.

In this embodiment, the home media server 24 transmits a legacy digital set-top box signal as well as a home network signal to networked thin-client devices at frequencies above 960 MHz. At the active reflector 36, the legacy set-top box signal is shifted to any video channel in the frequency band 750-860 MHz, a band that is usually not used inside the house, and is transmitted back into the house and received by the legacy digital STBs. In this embodiment, there is no multipath problem for legacy signals. Accordingly, any existing digital set-top box can receive and properly decode the legacy signal transmitted from the home media server 24. As each new thin-client device is installed, it is tuned to the home network frequencies.

Two preferred embodiments enable for the set-top boxes to receive legacy signals from the home media server. In the first embodiment, legacy signals comprise frequencies above 960 MHz. In the second embodiment, the network uses different frequencies to and from the active reflector 36. In this second embodiment, transmissions to the active reflector 36 comprise frequencies above 960 MHz, while transmissions from the active reflector 36 comprise frequencies between 750 MHz to 860 MHz. The shifting of the frequency of signals toward the active reflector 36 to the frequency of the signals from the active reflector 36 is performed by the active reflector 36.

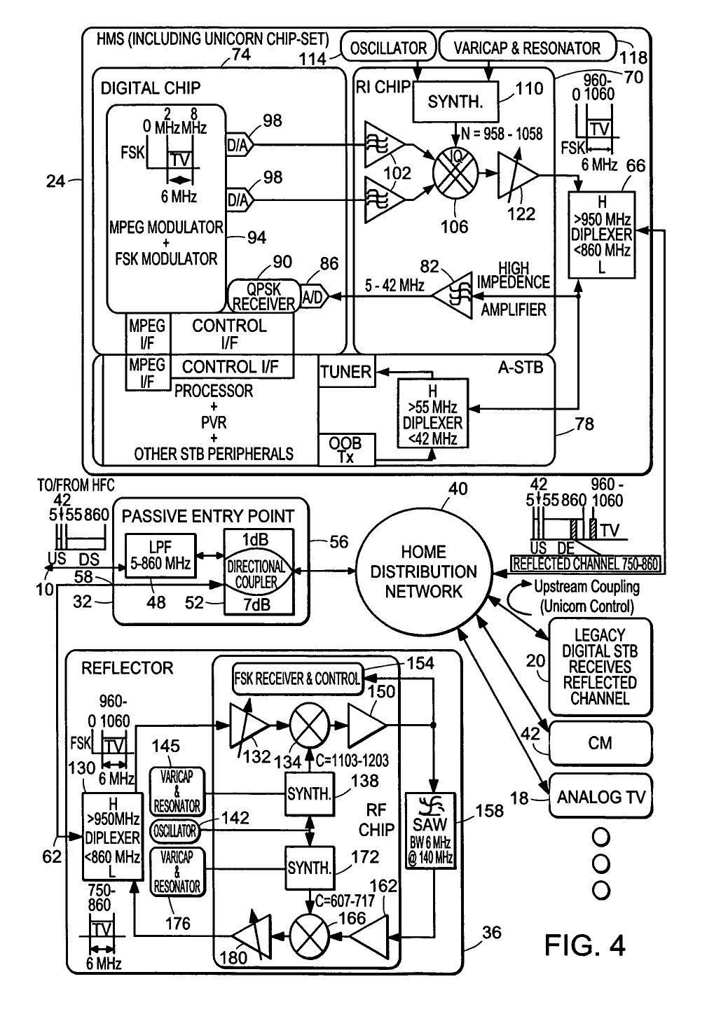

In more detail and referring to FIG. 4, the embodiment shown includes a home media server 24, a passive entry point device 32 and an active reflector 36 connected to the home distribution network coaxial wiring 40 and the external cable network 10. Also connected to the home distribution network 40 are also one or more legacy set-top boxes 20, cable modems 42, and/or analog televisions 18. Signals from the cable network 10 enter the home distribution network 40 through the passive entry point device 32. Signals entering or leaving the home distribution network 40 preferably fall within two bands: 5-42 MHz. for transmitting signals from the home distribution network 40 to the cable supplier head end; and 55-860 Mhz. for video signals from the cable network 10.

In the preferred embodiment, the passive entry point device 32 includes a low pass filter 48 and a directional coupler 52. In another embodiment, the entry point device 32 can comprise a demarcation point unit, for example, of the type described in co-pending U.S. patent application Ser. No. 10/234,358 entitled “Home Network and System and Method” by Kliger et al. (the “'358 patent”), the entirety of which is incorporated by reference herein. As described therein, the demarcation point unit preferably includes a blocking filter that receives a home network signal from the home network backbone and an external signal from the external network. The blocking filter separates the home network signal from the external signal, and returns the home network signal back to the home network backbone. In another embodiment, the demarcation point unit preferably includes a diplexer and signal reflector. The diplexer receives a home network signal from the home network backbone and an external signal from the external network. The diplexer separates the home network signal from the external signal. Further, the systems and methods described herein are designed to compliment and be used with the network, systems, methods and components of the '358 patent.

The signals preferably enter through the low pass filter 48 which passes both bands of the incoming signal to the directional 91 coupler 52. The directional coupler 52 preferably includes two output terminals. One of the directional coupler output terminals 56 is connected to the home distribution network 40. A second output terminal 58 is preferably connected to input terminal 62 of the active reflector 36. In various embodiments, the active reflector 36 can be physically located either at the entry point device 32 or within another room that is connected to the entry point device 32 through a coaxial cable, so long as there are no splitters 14 between the entry point device 32 and the active reflector 36.

Preferably, the home media server 24 includes a diplexer 66, an RF section 70, a digital signal processor 74 and a controller 78. The controller 78 preferably integrates the functionality of the home media server 24 with the video distribution functionality described below. In this embodiment, signals passing through the home distribution network 40 enter the home media server 24 through a diplexer 66. The 5-42 Mhz control signals transmitted from the legacy set-top box 20 enter the diplexer 66 and are amplified by a high impedance amplifier 82 in the RF section 70 prior to being digitized by an A/D converter 86 in the digital signal processor 74. The digital output from the A/D converter 86 is the input signal to a quadrature phase shift key receiver 90 which is connected to the controller 78 through a Control interface.

MPEG signals from the controller 78 are preferably sent to an MPEG modulator and frequency shift key modulator 94. The result signals are then preferably converted by two D/A converters 98 and passed into a pair of high impedance amplifiers 102 in the RF section 70. Signals from these amplifiers 102 are passed to a quadrature modulator 106. A third input into the quadrature modulator 106 is a signal from a synthesizer 110, preferably between about 958 and 1058 Mhz. The synthesizer 110 is preferably driven by at least two signals. One signal is from an oscillator 114 and the second signal is from varicap and resonator pair 118. The output of the quadrature modulator 106 preferably becomes the input to an adjustable gain amplifier 122 whose output is in turn connected to another input terminal of the diplexer 66.

Signals from the home media server 24 (preferably above about 960 MHz) pass over the coaxial wiring to the passive entry point device 32 but are prevented from entering the external cable network 10 by the low pass filter 48. These signals instead pass to the active reflector 36.

The signals enter the active reflector 36 by way of a diplexer 130. In the preferred embodiment, signals in about the 960-1060 MHz. range are passed to a variable amplifier 132 whose output is connected to an input terminal of a multiplier 134. The second input terminal of the multiplier 134 is connected to a synthesizer 138. The synthesizer 138 preferably has at least one input connected to an oscillator 142 and at least one input connected to a varicap and resonator circuit 146. The output of the multiplier 134 is the input signal to an amplifier 150. The output of the amplifier 150 is connected to a frequency shift key receiver 154 and controller 154 and to a surface acoustic wave filter having a bandwidth of about 6 Mhz. at about 140 Mhz.

The output of the surface acoustic wave filter 158 preferably forms the input signal to an amplifier 162. The amplifier 162 output preferably forms one input to a multiplier 166. The second input to the multiplier 166 is preferably formed by the output of a second synthesizer 172 whose input signals are from the oscillator 142 and a second varicap and resonator circuit 176. The output of the multiplier 166 preferably forms the input to a variable amplifier 180 whose output is the input signal to the diplexer 130.

In the operation of the preferred embodiment, the home media server 24 transmits its MPEG video signal at a frequency above the CATV signal (above 960 MHz) in the same format and modulation scheme as the head end of the external CATV network 10. This signal reaches the passive entry point device 32, from which it is forwarded to the active reflector 36. The active reflector 36 receives and down-converts the signal to the IF frequency, filters the TV signal and up-converts the TV signal to a predefined TV band (between 750 MHz and 860 MHz). The active reflector 36 then amplifies the TV signal according to control signals the active reflector 36 receives from the home media server 24 so that the level of the reflected signal will be equal to the level of the TV signals from the head end of the external cable network 10. In this embodiment, the legacy digital set-top box 20 can now receive MPEG2 video generated by the home media server 24, when the set-top box is tuned to a specific video channel. Alternatively, the legacy digital set-top box 20 can receive regular CATV programs when tuned to any other video channel. The channel used by the home media server video can not be the same channel as used by the head end of the external cable network 10.

In order to control frequency bands and gains used by the active reflector 36, a low bit-rate frequency shift key control channel is established between the home media server 24 and the active reflector 36 using the frequency shift key receiver and control 154 described above. In order to lock the receiver 154 to the changeable frequency, the home media server 24 preferably transmits a barker series or other chipping sequence continuously. The receiver 154 at the active reflector 36 searches until the receiver 154 detects and locks onto the designated frequency.

At initialization, the home media server 24 preferably selects an RF transmission frequency in the band of approximately 960 MHz-1060 MHz. The home media server 24 also selects a CATV channel frequency in the band between about 750 MHz-860 MHz. The home media server 24 then transmits control information on the selected control frequencies to the active reflector 36. Then the home media server 24 finds the RF received level of the CATV signals from the head end of the cable network 10 and transmits a default MPEG-TS video. The home media server 24 receives the TV signal and sends correction commands to the active reflector 36 until the correct gain is achieved.

It will be appreciated that the embodiments described above are merely examples of the invention and that other embodiments incorporating variations therein are considered to fall within the scope of the invention.

In view of the foregoing, what I claim is:

1. A system for distributing content to a set-top box connected to a home distribution network, the system comprising:
a home media server connected to said home distribution network;
a reflector; and
an entry point device having entry terminal for connection to a cable network, a first output terminal for connection to said home distribution network and a second output terminal for connection to said reflector,
wherein said content is sourced from both said home media server and said cable network,
wherein said content sourced from both said home media server and said cable network, is distributed over said home distribution network, and
wherein said content sourced from both said home media server and said cable network, is playable by said set-top box.

2. The system of claim 1, wherein said home media server communicates commands with said set-top box over said home distribution network using a command channel, and wherein said command channel uses the reverse data band.

3. The system of claim 1, wherein content from said home media server is carried over said home distribution network within a first predetermined frequency band.

4. The system of claim 1, wherein content from said cable network is carried over said home distribution network within a second predetermined frequency band.

5. The system of claim 1, wherein said home media server is controlled by a home media server control signal from said set-top box, and wherein said home media server control signal is carried over said home distribution network within a third predetermined frequency band.

6. The system of claim 1, wherein the home media server controls said reflector using a reflector control signal carried within a fourth predetermined frequency band.

7. The system of claim 1, wherein said entry point device is a passive entry point comprising a low pass filter connected to said entry terminal and a directional coupler connected between said low pass filter and said first and second output terminals.

8. The system of claim 1, wherein said reflector is an active reflector and said active reflector comprises:
a reflector input terminal;
a reflector diplexer having a first diplexer output and a first diplexer input and a second diplexer input connected to said reflector input terminal;
a reflector RF section having a first RF input connected to said first diplexer output, a second RF input, a first RF output connected to said first diplexer input, and a second RF output; and
a SAW filter having a SAW input connected to said second RF section output and a SAW output connected to said second RF section input,
wherein said active reflector receives signals in a first band and reflects them in a second band having a lower frequency than said first band.

9. The system of claim 8, wherein said RF section further comprises an FSK receiver and control unit connected to said second RF output.

10. The system of claim 1, wherein said home media server comprises:
a HMS diplexer having a first HMS diplexer input, a first HMS diplexer output and a second HMS diplexer input connected to said home media server input;
an HMS RF section having a first HMS RF section input connected to said HMS diplexer output, two second HMS RF section inputs, a first HMS RF section output connected to said HMS diplexer input, and a second HMS RF section output; and
an HMS signal processor having a first HMS signal processor input connected to said second HMS RF section output; and two HMS signal processor outputs, a respective one of said two HMS signal processor outputs connected to a respective one of said two second HMS RF section inputs.

11. The system of claim 1, wherein said home media server communicates with a demarcation point unit.

12. The system of claim 1, wherein the entry point device comprises a demarcation point unit.

13. A method for distributing content from a cable network and a home media server to a set-top box connected to a home distribution network, the method comprising the steps of:
passing content carried by a first predetermined frequency band from said cable network to said set-top box over said home distribution network;
passing control signals carried by a second predetermined frequency band from said set-top box to said home media server over said home distribution network; and
passing content carried by a third predetermined frequency band from said home media server to said set-top box over said home distribution network.

14. The method of claim 13, wherein said content is sent from said home media server to said set-top box in response to said control signals sent from said set-top box to said home media server.
